(19) United States
(12) Patent Application Publication
(10) Pub. No.: US 2011/0198450 A1
(43) Pub. Date: Aug. 18, 2011

(54) CABLE HOIST DEAD-END SYSTEMS AND METHODS

(75) Inventors: Randy G. Cloud, Mentor, OH (US); Adam Deel, North Olmsted, OH (US)

(73) Assignee: Preformed Line Products Company, Mayfield Village, OH (US)

(21) Appl. No.: 12/705,755

(22) Filed: Feb. 15, 2010

(51) Int. Cl. F16L 3/00; B66D 1/04; B66D 3/02; B66F 11/00

(52) U.S. Cl. 248/65; 254/266

(57) ABSTRACT

Systems and methods that enable a cable to be easily terminated at an elevated level are provided. The cable can be a strength member having a number of fiber optic storage loops disposed about its length. These loops can be strategically positioned upon a sidewall of a multi-dwelling building such that fiber optic service can be efficiently connected as desired. The systems can include a housing having a locking cavity where the cable is terminated. The housing includes entry and exit apertures that permit a pulling device such as mule tape to pass through. A locking mechanism can be positioned within the housing which engages a dead-end device connected to the cable thereby facilitating termination of the dead-end device at the elevated level. Upon termination, the dead-end device enables removal of the pulling device from ground level.

### BACKGROUND

An optical fiber is a glass or plastic fiber designed to guide light down its length by total internal reflection. Although fibers can be made out of transparent plastic or glass, most often, fibers used in long-distance telecommunications applications are glass, due to a lower optical attenuation. Both multi-mode and single-mode fibers are used in communications, with multi-mode fiber used mostly for short distances and single-mode fiber used for longer distance links. Oftentimes, these fibers are used in communication which permits digital data transmission over longer distances and at higher data rates than electronic communication.

In communication service provider applications, optical fibers are bundled as cables. Because light propagates through the fiber with little attenuation compared to electrical cables, use of fiber optic cables is especially advantageous for long-distance communications. By using optical fiber cables, long distances can be spanned with few repeaters. Additionally, the per-channel light signals propagating in the fiber can be modulated at substantially higher rates than conventional coaxial cables.

Today, optical fibers are becoming more and more common as a medium for networking and telecommunications. For example, television and Internet service providers are using fiber optics to deliver their services to customers in homes, multi-residence buildings and office buildings. Unfortunately, many of these structures are older which makes installation sometimes cumbersome and costly as, many times, optical cables must be fed through a structure's existing plumbing, electrical and heating ducts.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises systems and methods that enable a cable to be easily terminated at an elevated level. For example, the cable can be a strength member having a number of fiber optic storage loops disposed about its length. It will be understood that these loops can be strategically positioned upon a sidewall of a structure (e.g., multi-dwelling building) such that fiber optic service can be efficiently connected as desired.

In an aspect, the system includes a housing having a locking cavity where the cable can be terminated. The housing includes entry and exit apertures that permit a pulling device to pass through, e.g., mule tape from ground level. A locking mechanism can be positioned within the housing which engages a dead-end device connected to the cable thereby facilitating termination of the dead-end device at the elevated level.

Upon engagement, the dead-end device enables removal of the pulling device from ground level. For example, the pulling device can be a mule tape or rope. Engagement can be accomplished by way of a locking mechanism such as a free-floating locking pin. The pin can be constructed of galvanized or stainless steel.

In one aspect, the dead-end can be a helically wound wire device having at least two loops, wherein a pulling mechanism is attached to one of the loops and the other of the loops engages with the locking mechanism. The dual loops facilitate ease of removal of the pulling mechanism from ground level.

In other aspects, the dead-end device is a spring loop wedge cap that includes a plurality of wedge blocks that grip the cable and a spring loop that facilitates engagement with the locking mechanism. The spring loop can include a secondary loop configured for installation by and removal of the pulling mechanism. The spring loop can alternatively employ a crimp loop that is attached to the top of the spring loop and provides a secondary loop configured for installation by and removal of the pulling mechanism.

In still other aspects, the dead-end device can be a tapered wedge cap having a hooking mechanism that facilitates installation by and removal of the pulling mechanism. In this aspect, the locking mechanism can include a plurality of spring clips that compress upon insertion and lock once in position at termination.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates an example installation of a fiber hoist device having a mule tape inserted in accordance with an aspect of the innovation.

FIG. 2 illustrates an example connection of a strength member to one end of the mule tape in accordance with an example of the innovation.

FIG. 3 illustrates an example installation of a fiber hoist assembly and strength member having fiber coils in accordance with aspects of the innovation.

FIG. 4 illustrates an example flow chart of procedures that facilitate hoisting and terminating a strength member in accordance with an aspect of the innovation.

FIG. 5 illustrates a front perspective view of a hoist device in accordance with an aspect of the innovation.

FIG. 6 illustrates a front perspective view of a hoist device with its lid open in accordance with an aspect of the innovation.

FIG. 7 illustrates a rear perspective view of a hoist device in accordance with an aspect of the innovation.

FIG. 8 illustrates a front cross-sectional view of a hoist device in accordance with an aspect of the innovation.

FIG. 9 illustrates a side cross-sectional view of a hoist device in accordance with an aspect of the innovation.

FIG. 10 illustrates a top view of a hoist device in accordance with an aspect of the innovation.

FIG. 11 illustrates a bottom view of a hoist device in accordance with an aspect of the innovation.

FIG. 12 illustrates a perspective view of an engagement or latch pin in accordance with an aspect of the innovation.

FIG. 13 illustrates an example helically wound dead-end tether in accordance with an aspect of the innovation.

FIG. 14 illustrates spring loop wedge cap in accordance with an aspect of the innovation.

FIG. 15 illustrates an alternative spring loop wedge cap in accordance with an aspect of the innovation.

FIG. 16 illustrates an example crimp loop installed upon a spring loop wedge cap in accordance with an aspect of the innovation.

FIG. 17 illustrates an example hoist tapered wedge cap in accordance with an aspect of the innovation.

FIG. 18 illustrates a perspective view of an example loop device in accordance with aspects of the innovation.

FIG. 19 illustrates an example obstruction clamp in accordance with aspects of the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details.

The innovation provides systems and methods of lifting or otherwise hoisting fiber optic cabling to structures such as multi-unit dwelling and office buildings. As described above, today, fiber cabling is becoming more and more common for television and other communication and network service providers. While the examples described herein are directed specifically to fiber optic cabling, it is to be understood and appreciated that the features, functions and benefits of the innovation can be applied to most any type of cable, wire, lead, etc. without departing from the spirit and/or scope of the innovation.

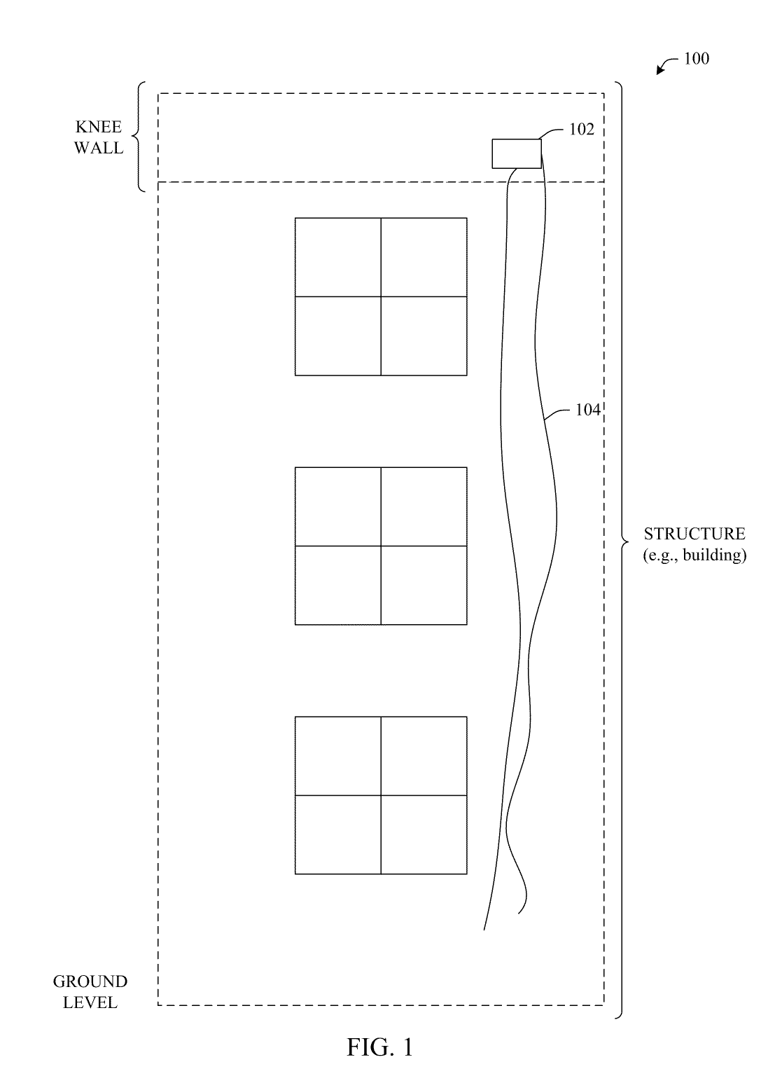

Continuing with the discussion above, conventional installation of fiber optic cabling into existing structures most often required access to air ducts, furnace ducts, plumbing, etc. Unlike conventional approaches, the innovation described and claimed herein facilitates ease of entry into structures from the outside of the structure. More particularly, as shown in FIGS. 1, 2 and 3, the innovation provides techniques by which fiber optic cabling can be effectively lifted or hoisted from ground level to an elevated position of the structure. The cabling that is hoisted can include a coiled portion(s), for example at each floor of the structure. In this way, when fiber optic cabling is desired (e.g., subscription to television or network services), the loop provides cabling outside a wall or window for efficient access. One traditional problem with using these coiled storage locations is that it difficult to lift the strength member along the sidewall of a structure to put in position outside each window. Aspects of the innovation provide an efficient manner by which fiber cabling can be hoisted to a sidewall of a structure.

Referring initially to the drawings, FIG. 1 illustrates an example deployment 100 of the innovation. More particularly, FIG. 1 illustrates a multi-level structure having a knee wall that spans the perimeter of the top. As will be understood, a “knee wall” most often describes a short wall not more than three feet in height that is constructed around the perimeter of a flat top structure or building. One advantage of such a wall is to offer a security ledge upon the roof of the structure.

As shown in the example of FIG. 1, a hoist device 102 can be installed on the outer wall of the knee wall. This hoist device 102, along with a mule tape or rope 104, can be used to hoist a cable from ground level to the upper portion of the side wall of a structure. In operation, a contractor or craftsman can install the hoist device 102, thread the mule tape or rope 104 and drop the same toward ground level as shown. The mule tape or rope 104 can be affixed or otherwise tied off for later use. For security purposes, it is to be understood that the mule tape or rope 104 can be tied off above the normal reach of an individual (e.g., 10 or 12 feet above ground level).

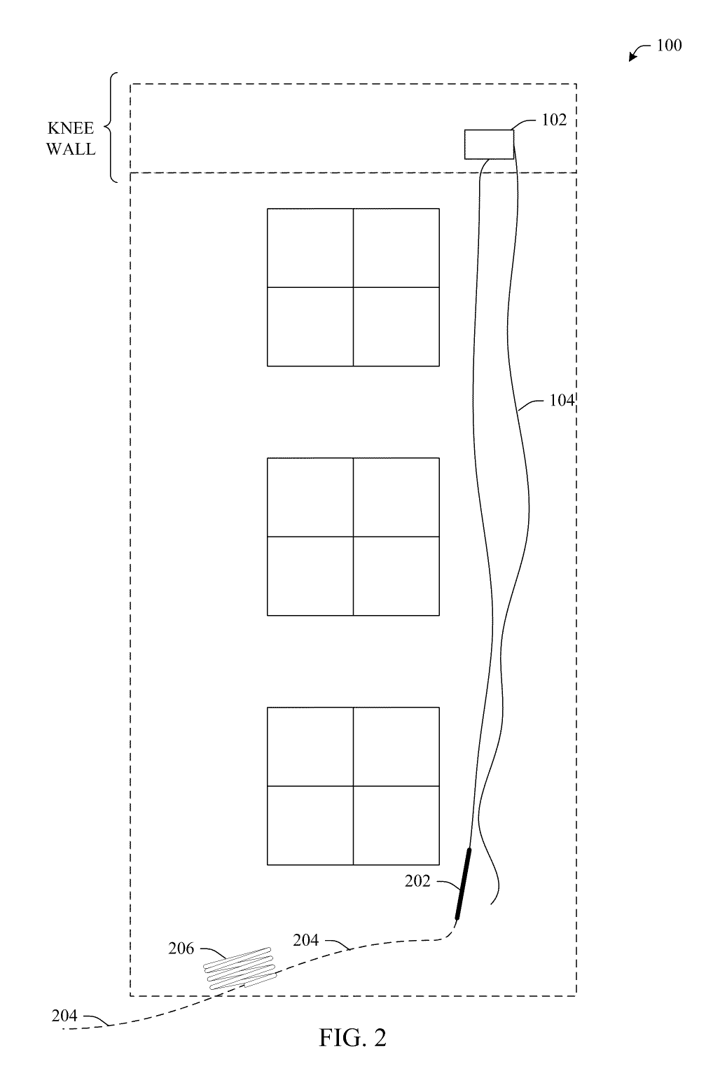

In order to install cabling, an installer, such as a service provider, can connect a dead-end to one end of the mule tape or rope 104. As shown in FIG. 2, in a fiber optic cabling example, a dead-end or tether 202 can be used to affix strength member 204 having coils of fiber 206 attached thereto. Once affixed as illustrated in FIG. 2, the other end (e.g., the un-affixed end) of the mule tape or rope 104 can be pulled through the hoist device 102 thereby causing the dead-end 202, strength member 204 and coils 206 to rise along the sidewall of the structure. It will be appreciated that the hoist device 102 can be equipped with a pulley or other mechanical treatment that enables the mule tape or rope 104 to enter and exit a point within (or about) the hoist device 102. However, in the example described, strategically positioned pathways facilitate direction of the mule tape through the hoist device 102.

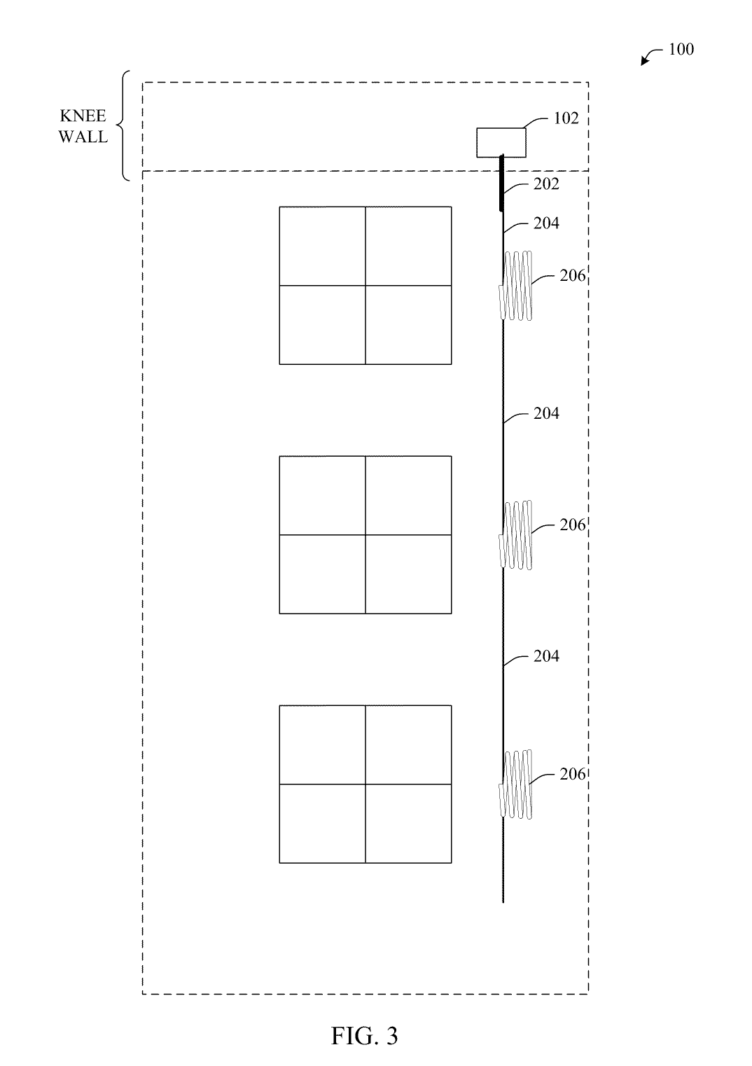

FIG. 3 illustrates a hoisted strength member 204 once the mule tape or rope (104 of FIG. 1) is removed. As will be understood upon a review of the figures that follow, the dead-end 202 can be constructed in such a manner to enable easy removal of the mule tape or rope once locked. Returning to FIG. 2, once the dead-end 202 is hoisted to the hoist device 102 via the mule tape or rope, the dead-end 202 locks into the hoist device 102 causing the dead-end 202 to be fixedly connected within the hoist device 102. In one example, a rotating pin can be used to secure the tether 202.

As described in greater detail infra, the dead-end 202 can be constructed or configured in such a manner so as to enable engagement into the hoist device 102 while enabling the mule tape or rope to be removed from ground level. It will be appreciated that the features, functions and benefits of this hoist device 102 system design can alleviate conventional complexities of installing cables along sidewalls of buildings and structures.

In an alternative example, an obstruction clamp can be attached to the tether 202 thereby prohibiting entry into the hoist device 102. In other words, an obstruction clamp can be attached to one end of the strength member or dead-end thus, upon contact with the aperture on the bottom of the hoist device 102, the obstruction clamp prohibits entry and subsequent locking of the tether 202 within the hoist device 102. It will be appreciated that this obstruction clamp can be used in a test or measurement phase thereby enabling a worker to efficiently and easily establish an optimum length of the strength member. Once a measurement is established, the obstruction clamp can be removed thereby permitting the tether 202 to enter the aperture of the hoist device 102 and subsequently lock into position. It is to be appreciated that the functionality of the obstruction clamp can be configured into the tether 202 in aspects.

In one embodiment, the obstruction clamp is formed with two legs that extend beyond the diameter of the bottom aperture of a hoist device 102. Accordingly, in operation, the legs contact the bottom face of the hoist device 102 prohibiting access. In one aspect, once an installer determines the measurements are correct, the tether can be lowered and the legs can be snipped or cut off to facilitate entry and subsequent locking into position. In other aspects, the legs can be configured to fold or break off when a predetermined amount of force is applied. For example, once a measurement is made, a greater amount of force can be applied to the mule tape causing the legs to break (or fold) from the obstruction clamp. While an obstruction clamp is described to have “legs,” it is to be understood that most any shape that obstructs entry can be employed without departing from the functionality described herein. Additionally, the obstruction clamp can be designed or manufactured of most any rigid material, including but not limited to, plastic (molded or otherwise manufactured), metal, or the like.

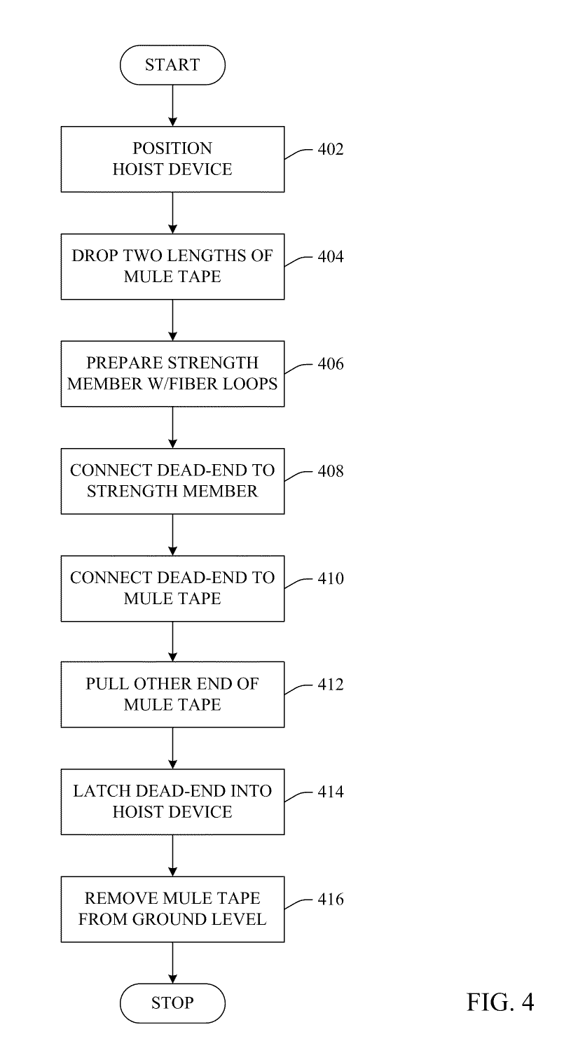

FIG. 4 illustrates a methodology of hoisting a cable upon a sidewall of a structure in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. Moreover, not all illustrated acts may be required to implement a methodology in accordance with the innovation.

In operation and as shown in FIG. 4, at 402, a hoist device can be positioned or installed upon the outer side of a knee wall atop a structure. For example, the hoist device can be permanently attached (e.g., bolted into the mortar or brick of a structure). In other aspects, a temporary or permanent bracket can be installed (e.g., around the knee wall) to secure the hoist device. In an aspect that employs a temporary bracket, once the strength member and fiber loops are hoisted, they can be affixed to the structure outer wall and the hoist device can be removed.

In one aspect, at 404, two lengths of the mule tape can be dropped from the top of the structure to ground level. More particularly, mule tape or a rope can be installed through the device, the cover closed and the mule tape or rope can be dropped down the sidewall of the structure. At or above ground level, the mule tape or rope can be tied off, for example, ten or twelve feet from ground level.

At 406, a strength member can be prepared with fiber loops as described above. Later, when cabling is desired to be lifted up the sidewall, a craftsman can affix a tether or dead-end to the connection above ground level in order to hoist the cable up the side of the structure. In other words, at 408, a dead-end can be connected to the strength member and, at 410, the dead-end is attached to one end of the mule tape. The other end of the mule tape or rope can be pulled at 412 in order to lift the dead-end with cable affixed to a desired height.

One device used to connect the strength member to the mule tape is a helical wire dead-end device that wraps around the strength member (e.g., cable). As described above, the mule tape (or rope) can be attached to the dead-end device and used to elevate the strength member having fiber optic loops attached thereto. The helically wound device can be configured or oriented in such a manner that it is able to grasp the cable such that the craftsman can pull the mule tape or rope thereby lifting the cable to the knee wall location. Once the desired height is reached, at 414, the dead end device locks into the hoist apparatus. Finally, at 416, the mule tape or rope can be removed from ground level.

In accordance with the methodology of FIG. 4, upon installation, a craftsman would measure (or previously know) how much cable is needed to reach the hoist apparatus. In one aspect, the mule tape can be marked with measurements so as to efficiently advise of a proper length. Once determined, a strength member cable is cut to a desired length. As described supra, the strength member cable would have fiber optic coils strategically located at various points within its length. These coils are used to efficiently provide fiber optic access, for example, when a customer purchases a television or networking services from a provider.

Returning to act 412, in one aspect, a pin that performs as a rotating spring-like mechanism can float within the hoist apparatus. When the loop of the tether engages the pin, it locks into position within the hoist mechanism thereby retaining the strength member atop the structure. The dead-end can be orientated such that the mule tape or rope can be easily removed upon engagement and/or locking into the hoist device.

For example, a helical device can be conformed or configured with a double loop or conformed from a plastic or metal attachment to create an extra loop such that the mule tape or rope can be entered into one of the loops and the locking pin can engage the other. It will be understood that this arrangement can enable the tether or dead-end to remain locked into place while the rope is easily removed via the other loop, for example, from ground level.

In other aspects, a wedge-block-equipped device can be used as a dead-end to retain the strength member cable upon hoisting. This wedge-equipped device can be configured with an attachment means that enables the dead-end to latch to a locking means. Additionally, this attachment means can permit the mule tape or rope to be withdrawn from ground level. While specific dead-end examples of attaching the strength member for hoisting, it is to be understood and appreciated that alternatives (e.g., netting) exist that can be employed to facilitate effective attachment, locking and rope removal. These alternatives are to be included within the scope of this disclosure and claims appended hereto.

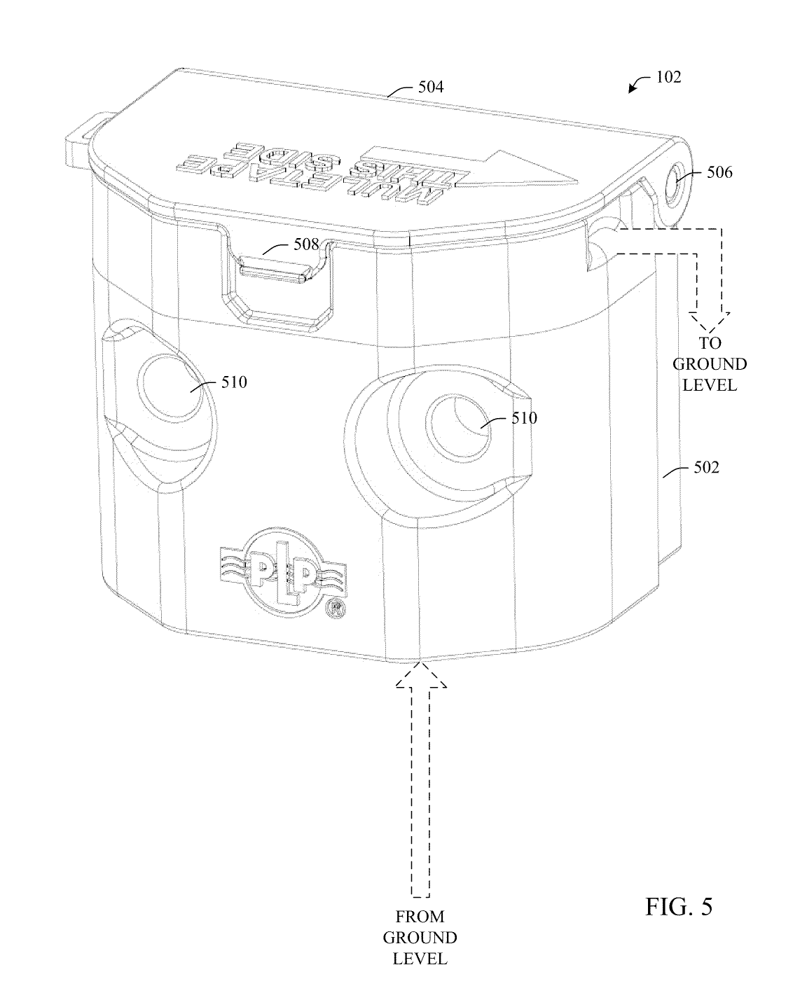

Turning now to FIG. 5, illustrated is a perspective view of a hoist apparatus 102 in accordance with an aspect of the innovation. While specific configurations and design options and treatments are shown, it is to be understood that alternative aspects can include other design options and configurations without departing from the spirit and scope of this disclosure and claims appended hereto. Accordingly, these alternative aspects are to be included within the scope of this disclosure and claims appended hereto.

As shown, apparatus 102 is constructed of a housing 502 having a lid 504. In this example, the lid 504 employs a hinging means 506 that enables the lid 504 to hinge into an open position. When closed, the lid 504 can be equipped with a latching means 508 that retains the lid 504 in the closed position. The example latch 508 is a pressure-actuated latching means. Other latching means can be used in alternative designs. Similarly, the hinging means 506 is optional such that alternative embodiments can employ a snap-fit lid design (not shown). It is to be appreciated that these alternatives are but examples of numerous design options—all of which are to be included within the scope of this disclosure and claims appended hereto.

As will be described in greater detail below, the interior of the housing 502 includes a locking mechanism capable of capturing a tether or dead-end as previously described. An example locking mechanism as well as example dead-end designs will be described in greater detail upon a review of the figures that follow.

The dashed arrows indicate a direction of travel of the aforementioned mule tape in accordance with this aspect. In other words, the mule tape is threaded through the bottom surface of the housing 502. After passing through the locking mechanism chamber, the mule tape exits the housing 502 on the upper right area as shown. Upon exiting, the mule tape travels back into the direction to ground level. Thus, the mule tape can enter the housing 502 from ground level, pass through the locking chamber (not shown) and exit out the top side of the housing 502 back to ground level as indicated by the dashed arrow.

The housing 502 can also be equipped or configured with attachment means or mounting apertures 510. While two separate apertures 510 are shown, other aspects can employ more or fewer apertures to suitably mount the device 102. Although not shown, an alternative design can be employed along with a mounting bracket (not shown) (e.g., around a knee wall). These and other alternatives as will be appreciated by those skilled in the art are to be included herein.

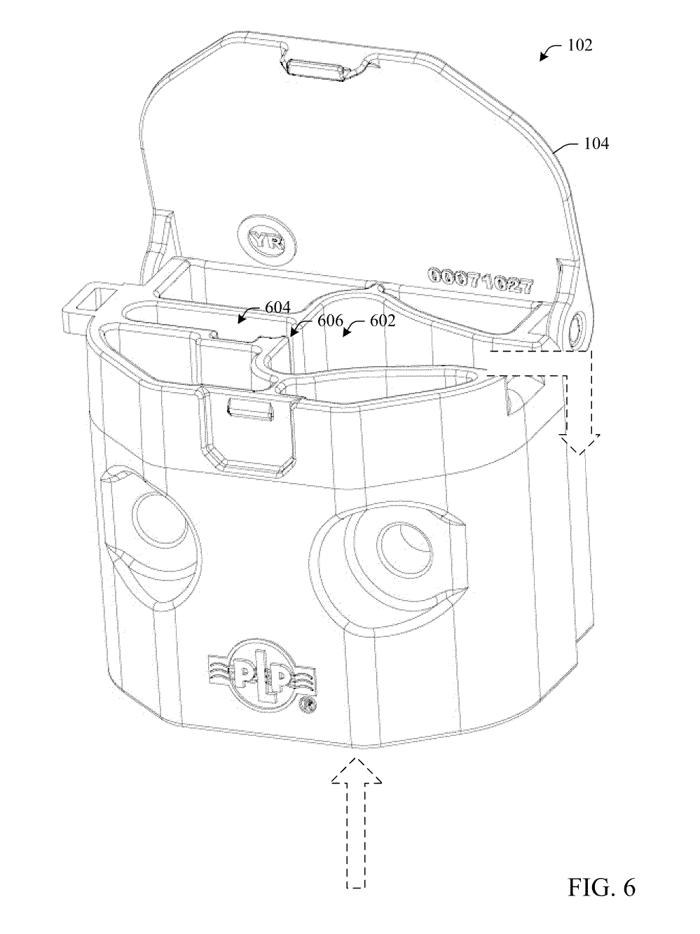

FIG. 6 illustrates an alternative perspective view of the embodiment of FIG. 5. In particular, FIG. 6 illustrates the lid 504 in an open position thereby exposing the locking cavity or chamber 602. This locking cavity 602 is shaped in such a manner so as to allow the mule tape (or rope) to freely enter and exit the cavity 602. Also illustrated by the open lid 504 is a pin cavity 604 that is in communication with the locking cavity 602. In other words, as will be better understood upon a discussion of the example locking pin (not shown) the pin cavity 604 houses a free floating spring-clip pin. A portion of the pin travels from the pin cavity 604 to the locking cavity 602 via a common or shared opening 606 (e.g., slot) between the two cavities 602, 604.

It is to be understood that the housing 502 and lid 504 can be manufactured from most any suitably rigid material. In the illustrated example, it is contemplated that the housing 502 and lid 504 are molded from plastic; however, other materials such as metals, composites, fiberglass, etc. can be employed without departing from the spirit and scope of the innovation. The locking pin as will be described later is manufactured of metal in the example. Similar to the other components, it is to be understood that other suitably rigid materials (e.g., plastic) can be used to manufacture the locking pin without departing from this disclosure.

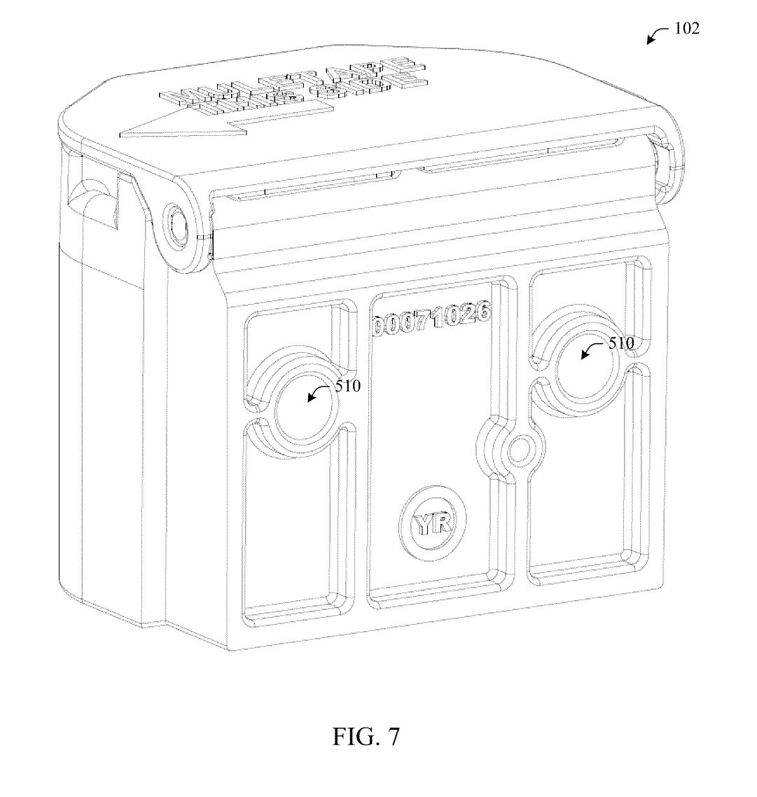

FIG. 7 illustrates a rear view of apparatus 102 in accordance with this example embodiment. As shown, the mounting apertures 510 or means are in communication from the front side of the device to the rear as shown in FIG. 7. These apertures 510 are configured to accept standard hardware bolts, for example, for fixedly attaching the device 102 to a sidewall of structure as shown in FIGS. 1, 2 and 3.

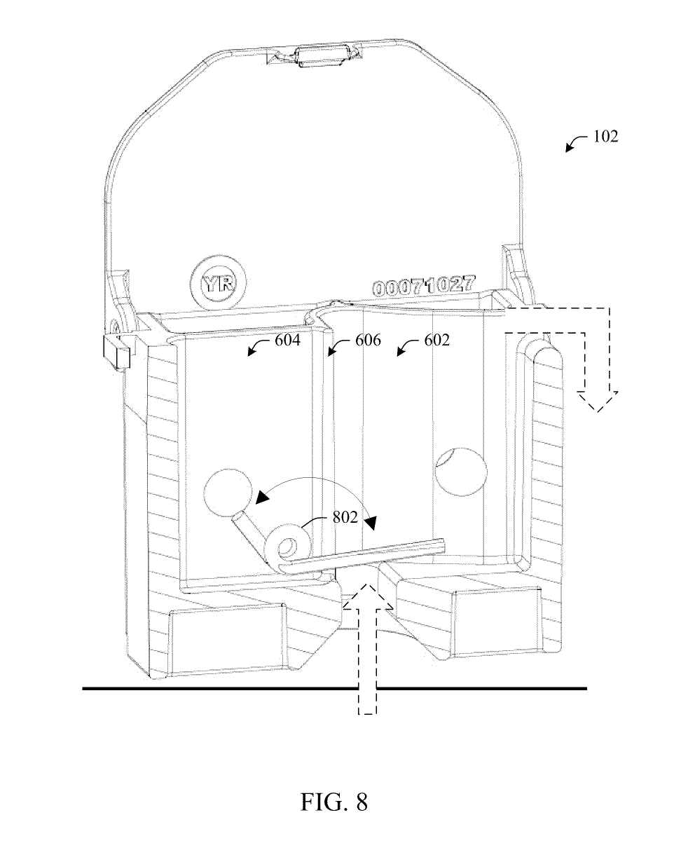

Referring now to FIG. 8, a front cross-sectional view of the example hoist apparatus 102 is shown. Consistent with the figures described earlier, dashed arrows are illustrated to demonstrate the path of the mule tape. Additionally, each of the locking cavity 602, pin cavity 604 and shared opening or transition 606 is illustrated in the cut-away view. The free floating pin 802 is able to pivot about its coiled section as depicted by the arc arrow.

Upon transitioning the mule tape through the bottom of the apparatus 102, the dead-end (202 of FIG. 2), which is removably attached to the mule tape, contacts the pin 802 forcing it to pivot in an upward direction. Because the dead-end is treated with a connector (e.g., multi-loop design), the dead-end engages the pin 802, the pin 802 rotates and springs back to its locked position (as shown) and retains the dead-end in place. Thereafter, the mule tape can be pulled from the ground and disengaged from the dead-end.

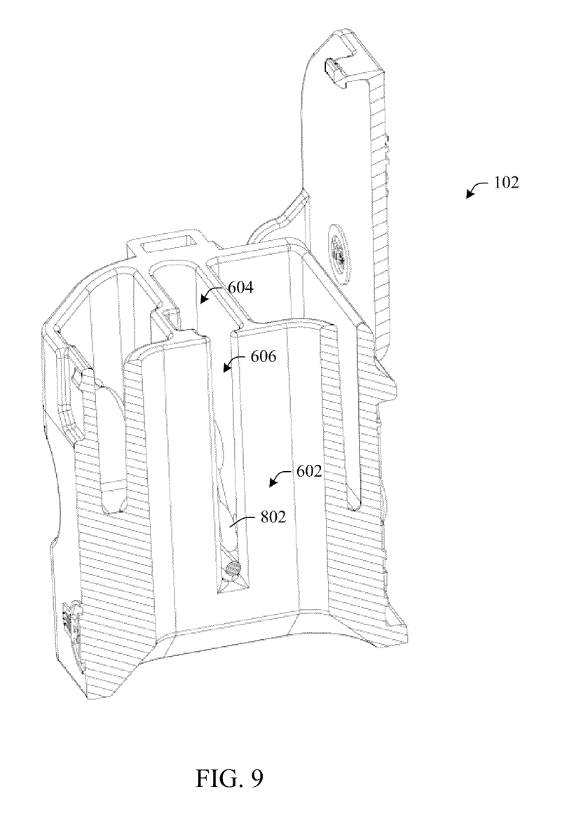

FIG. 9 illustrates an alternative side cross-sectional view of the apparatus 102. As illustrated, the pin 802 spans the transition 606 between the pin cavity 604 and the locking cavity 602. It will be appreciated that the cavities 602, 604 and the transition 606 are configured and sized to promote ease and efficiency of operation (e.g., mule tape motion and dead-end engagement).

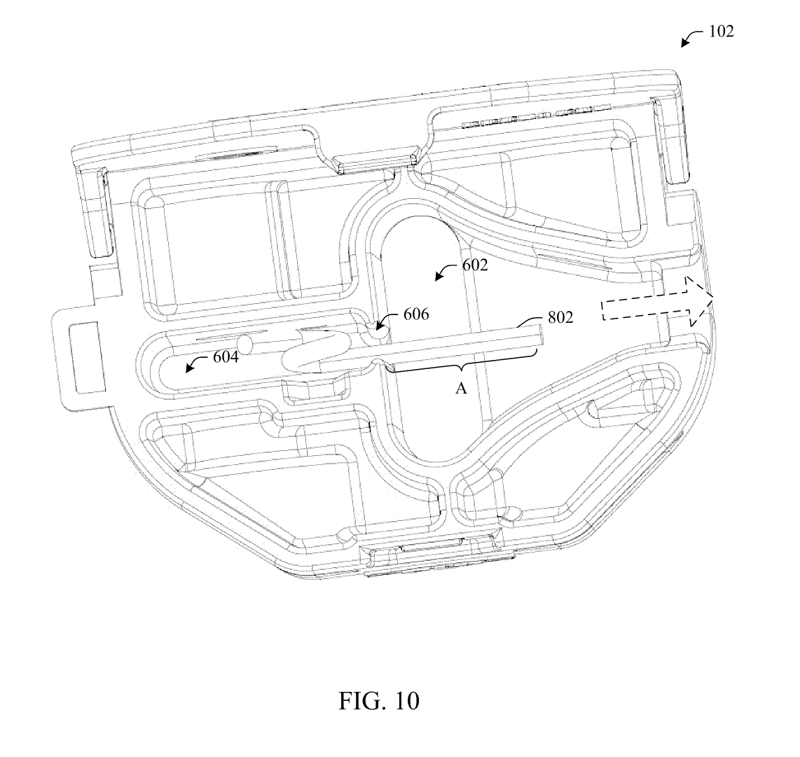

FIG. 10 illustrates a top view of apparatus 102. As shown in FIG. 10, portion “A” of pin 802 is indicative of the portion that engages the dead-end attached to the strength member. As described supra, upon initial contact with the dead-end, pin 802 pivots upward to allow the dead-end loop (or attachment means) to pass. Once passed, the pin 802 pivots downward engaging the loop of the dead-end. It will be appreciated that the pin 802, as shown, can be equipped with spring-like properties. This spring (preload or winding) mechanism assists in proper and efficient engagement.

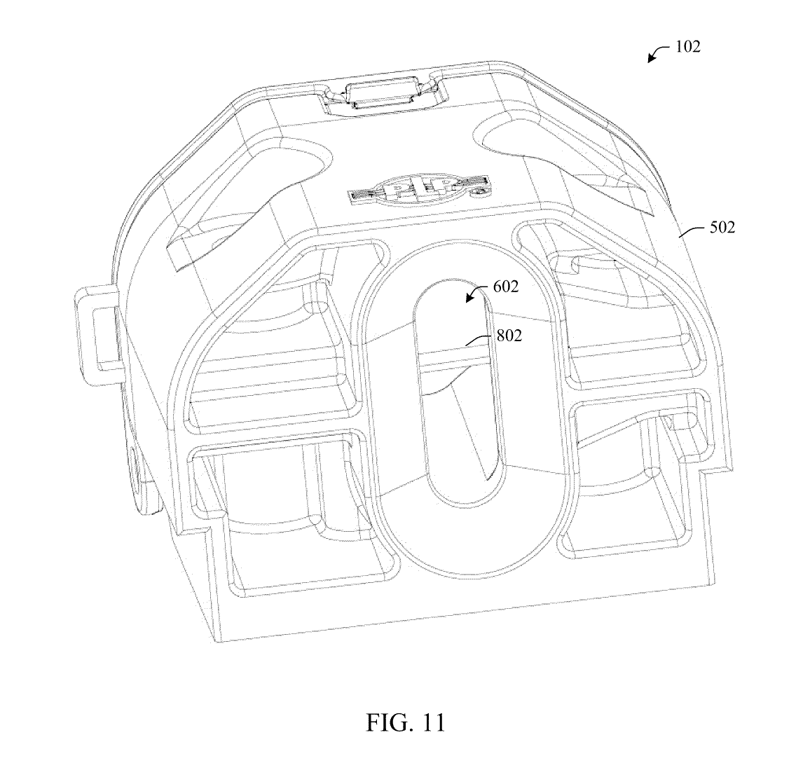

FIG. 11 illustrates a bottom side view of the hoist device 102 in accordance with the example embodiment. As shown, an oval shaped aperture can be employed to enter the locking cavity 602 from the underside of the housing 502. The oval opening can have tapered entry sides which assist in lowering motion friction of the mule tape into the housing 502. These tapered sides along with the shape of the opening facilitate proper alignment of the dead-end to ensure efficient termination with the locking pin 802. The locking pin 802 is illustrated in FIG. 11 in the locked-down position. As previously stated, while specific configurations and orientations are illustrated, it is to be understood that alternative designs can be employed without departing from the features, functions and benefits of the innovation as disclosed and claimed herein.

Essentially, the hoist apparatus 102 can be a mountable base structure with a spring-like clip or pin 802 that secures a dead-end or similar loop-like product (e.g., tether) that is hoisted up for termination. As shown, the bottom surface has a slot with a tapered opening that can guide the dead-end into place regardless of the initial orientation. As the dead-end travels through the slot, a spring action clip or pin 802 secures the dead-end into place. The spring-action clip 802 can be formed with one leg longer than the other. The longer leg is used to secure the dead-end into place and the shorter leg can be bent at an angle that will not permit the longer leg from rotating more than 90 degrees so as to ensure a positive engagement with the dead-end or tether.

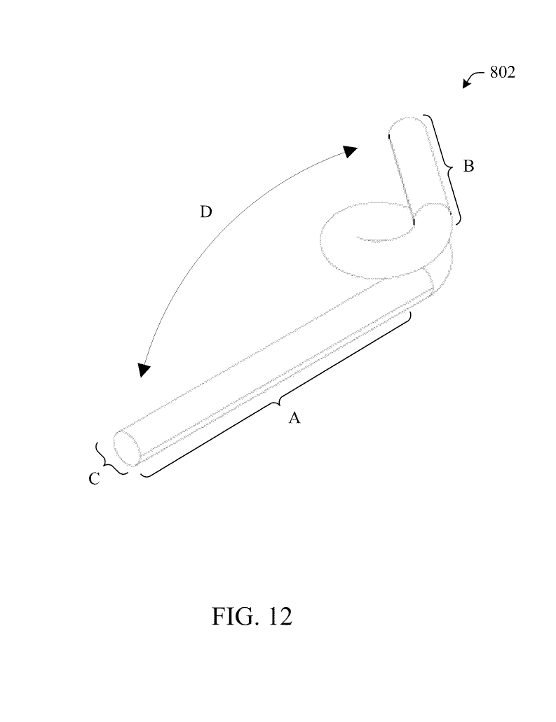

FIG. 12 illustrates a perspective view of a locking pin 802 in accordance with the described embodiment. In this aspect, the pin can be manufactured of metal, e.g., galvanized or stainless steel. The coiled portion can provide preload or spring-like properties that assist in sufficient and efficient locking of the dead-end within the housing. Consistent with the aforementioned description, portion “A” includes the area that engages with the dead-end loop. In one specific example, the length of “A” can be 1⅜ inches. This length “A” resides within the locking cavity as described.

Portion “B” resides within the pin cavity of the housing. In one specific example, the length of portion “B” can be ½ inch. The diameter “C” of the pin, in one aspect, can be ⅛ inch. Further, the arc “D” can be, in this aspect, 125 degrees. While specific dimensions of pin 802 are described, it is to be understood that these dimensions are provided to add perspective to the innovation and not intended to limit the scope of this innovation in any manner. While the locking pin is shown and described as a coiled stainless or galvanized steel pin, it is to be understood that other locking mechanisms and pins can be employed without departing from the features, functions and benefits of the innovation. For example, pins that can be cut (e.g., laser cut) from sheets of metal are to be included within the scope of this specification. These and other variations of locking pins or mechanisms are to be included within the scope of this disclosure and claims appended hereto.

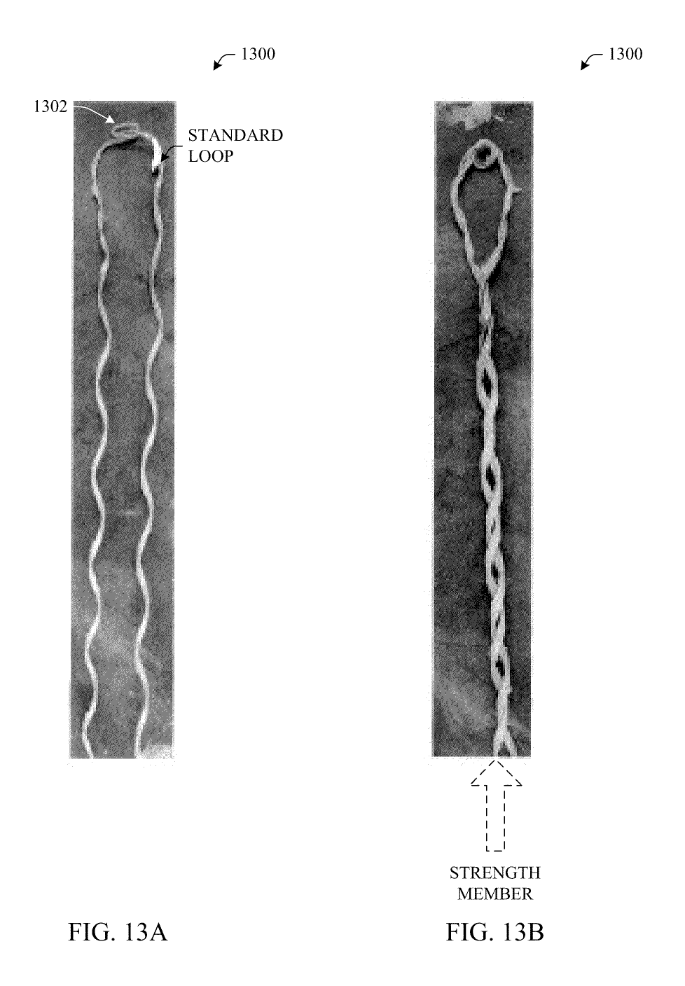

FIGS. 13A and 13B illustrate an example dead-end or tether 1300 in accordance with aspects of the innovation. The tether, or dead-end, has a substantially similar forming structure of a standard helically wound dead-end. In addition, as shown, the tether 1300 is formed to have an additional loop 1302 incorporated in either the top or bottom of the standard loop. As disclosed above, this additional loop 1302 can be employed with most any pulling tool. In the described example, the pulling tool is a “mule tape” or rope which can be used to hoist the dead-end 1300 to its termination location (e.g., within hoist apparatus 102 of FIG. 1). The extra loop 1302 protects the mule tape from being pinched between the dead-end 1300 and the supporting pin (e.g., 802) at termination allowing for easy assembly at installation and removal of the rope following termination. While the example of FIG. 13A illustrates the additional loop 1302 above the standard loop, it is to be understood that other aspects employ the additional loop 1302 below (or within) the standard loop. These and other contemplated aspects are to be included within the scope of this specification.

It will be understood by those knowledgeable in the art that, a strength member or cable can be inserted within the helical wires as shown in FIG. 13B. The helical wires can grasp the strength member thereby facilitating hoisting to the termination location. Other aspects can attach to the strength member in other manners. For example, netting (not shown) can be used to encompass the strength member thereby adhering for hoisting to the termination location.

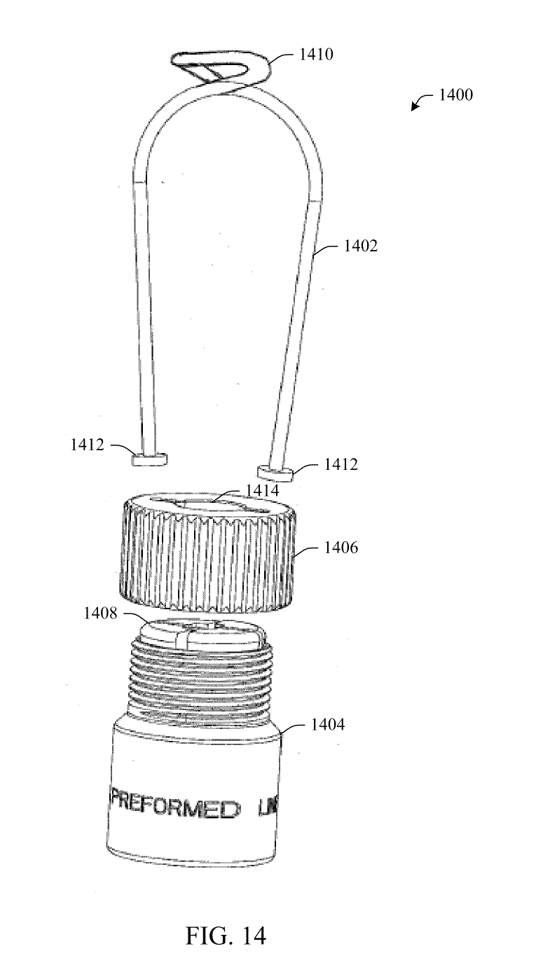

FIGS. 14-16 illustrate other alternative manners by which a strength member can be formed to facilitate a dead-end at a hoist device as shown in FIG. 1.

Referring first to FIG. 14, a dead-end connector 1400 is shown. As illustrated, the connector 1400 can include a wire loop 1402, a base 1404 and cap 1406. The base 1404 encapsulates a series or plurality of wedge blocks 1408 that, when the cap 1406 is tightened upon the base 1404, the wedges 1408 capture and tighten around a cable or strength member.

The wire loop 1402 or fiber hoist spring loop can be a standard wire loop with an additional smaller loop 1410 on the top and “nail heads or bent legs” 1412 at the ends. When the ends 1412 are squeezed together, they will spring back into a notch or groove 1414 in the cap 1406. The nail heads 1412 hold the wire loop 1402 from being pulled out of the cap 1406. As described with regard to the dead-end of FIGS. 13A and 13B, the additional loop 1410 on the top loop can be employed with most any pulling tool, e.g., mule tape or rope. The mule tape can be attached to the smaller loop or attachment loop and the wedge clamp device 1400 can be hoisted to pull a strength member or cable to position for termination.

It will be understood that the extra loop 1410 can protect the mule tape from being pinched between the spring loop 1402 and the supporting pin (e.g., 802 of FIG. 8) at termination. This will allow for easy assembly at installation and removal of the tape or rope from ground level following termination.

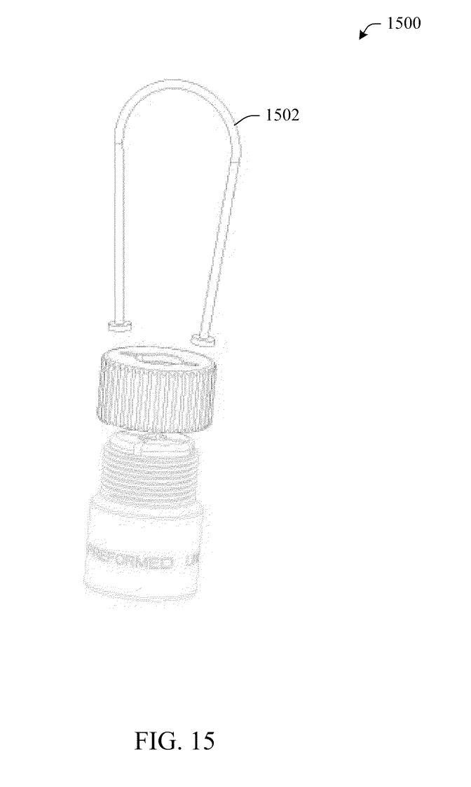

FIG. 15 illustrates an alternative example of a fiber hoist tapered wedge device (e.g., dead-end) 1500 in accordance with aspects. As shown, the spring loop 1502 of the device 1500 employs a single loop rather than a dual loop as shown in FIG. 14. In operation, the spring loop 1502 is installed in a similar manner and used to terminate via a retention pin as previously described.

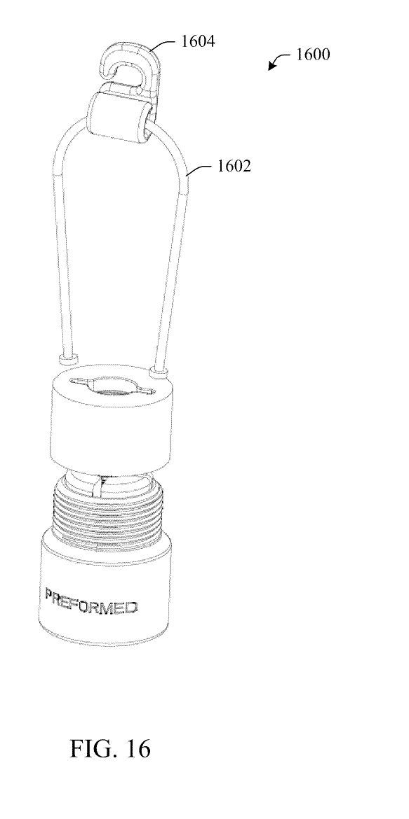

FIG. 16 illustrates yet another example of a fiber hoist tapered wedge device 1600 in accordance with aspects. The operation of this device 1600 is similar to that of the devices of FIGS. 14 and 15; however, the spring loop 1602 is equipped with a crimped-on second loop 1604. As will be understood in view of the previous discussion, this second loop 1604 can be employed with most any pulling device, e.g., mule tape or rope. Additionally, the crimped second loop 1604 can facilitate easy installation and removal of the mule tape or rope upon engagement at termination.

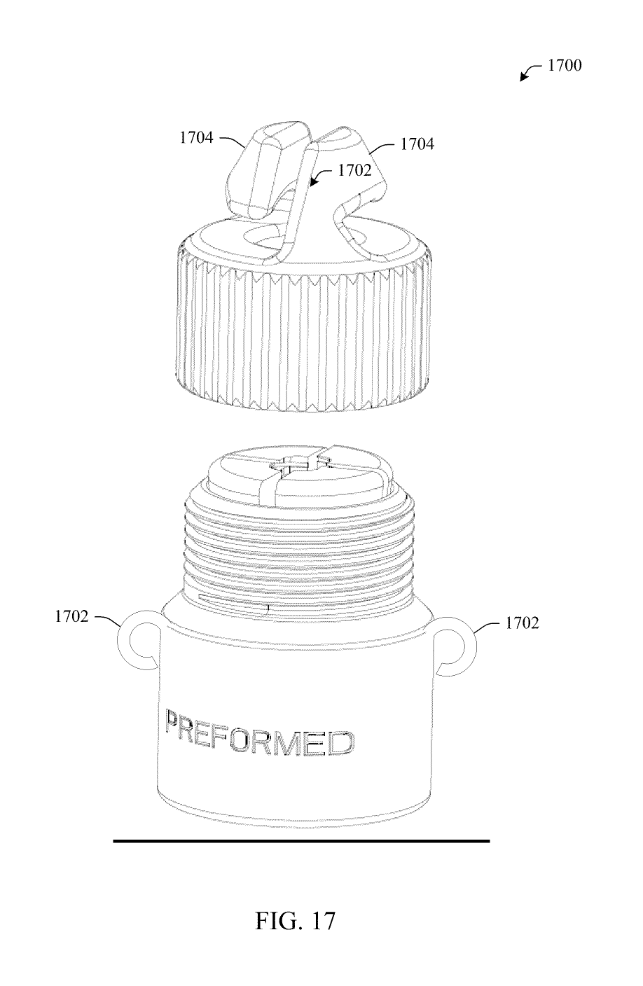

FIG. 17 illustrates yet another example cap device 1700 in accordance with aspects of the innovation. The device 1700 employs a cone-shaped design 1702 that performs as a self-guiding feature which allows it to pass through a tapered hole in a locking device for termination of a cable (or strength member). In this example, the tapered hole would be disposed within the hoist device (e.g., 102 of FIG. 1). This ensures that the wedge clamp device 1700 will be orientated correctly and pass through the locking device with ease. The device 1700 can also have a hooking feature built-in such that a rope or mule tape loop can easily be secured to the cap for hoisting.

The hooks 1704 are oriented in opposing directions to each other so that the rope or mule tape does not easily become removed or slip off. Once the wedge travels through the tapered hole of the mounting device (or hoist device), a spring-like feature can fully engage securing the wedge 1700 in place. In this example, the spring-like feature has tabs 1706 (e.g., four tabs) that have a spring action so that they can compress while travelling through the hole, but then spring back to their original state after clearing the hole. In result, the wedge is fully terminated at the desired location. It is contemplated that other retention and/or spring attachment means can be employed in other aspects. These alternatives are to be included within this disclosure and claims appended hereto.

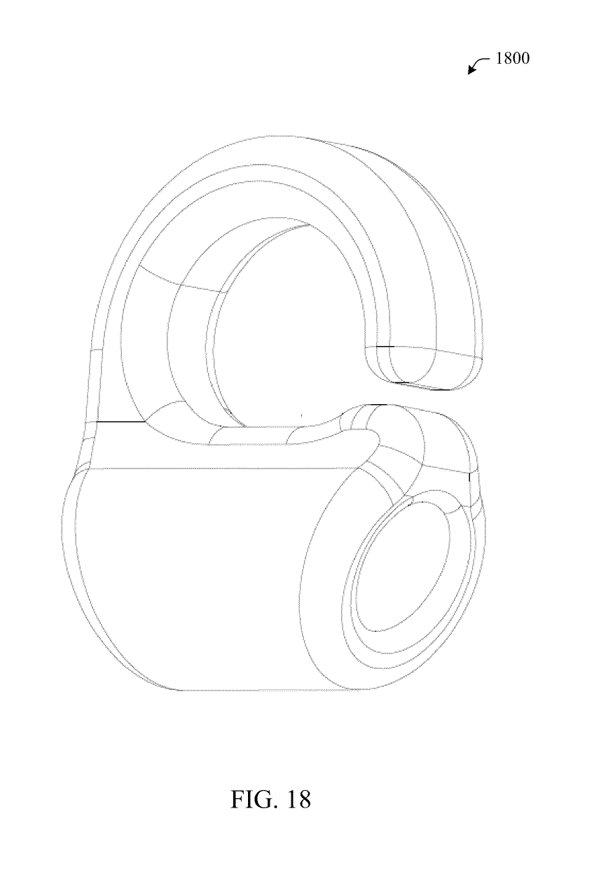

FIG. 18 illustrates yet another aspect of a connection device 1800 in accordance with the innovation. In accordance with this aspect, the “loop” located at the top is not merely a bent circle on the top of a wire, using the wire itself. Rather, the loop is a separate piece 1800 as shown in FIG. 18. In aspects, this device 1800 can be molded from plastic or manufactured from other suitably rigid material. The device 1800 can snap or press fit onto the top of the dead-end, wire or strength member.

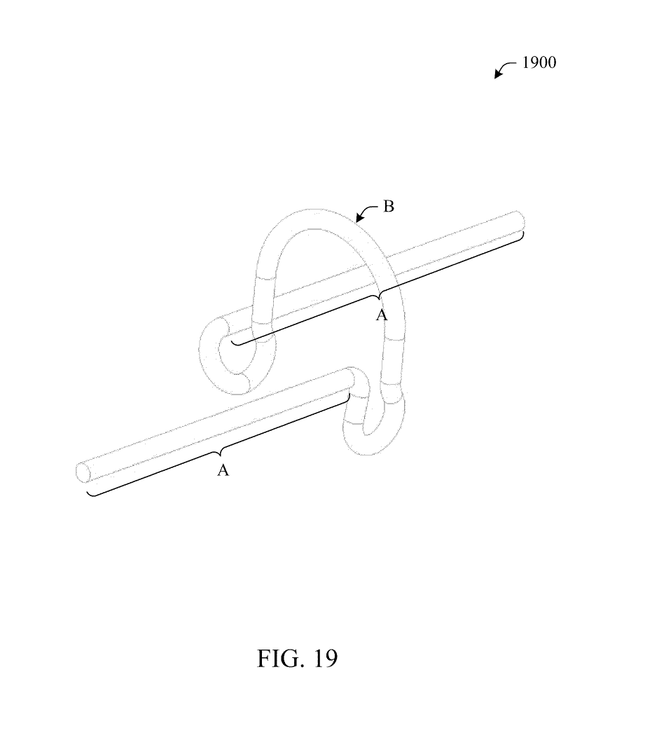

FIG. 19 illustrates an example obstruction clamp 1900 as described above. For example, the obstruction claim of FIG. 19 can be used to prohibit entry and locking of a dead-end device. Using this example with respect to obstruction clamp 1900, once the installer determines that measurements are correct, the tether can be lowered down the structure sidewall and the legs (A) snipped off so that it can be permanently installed. As shown, this obstruction clamp 1900 also has the looped feature (B) that allows the mule tape (or rope) to easily be removed. As stated above, it is to be appreciated that other aspects of obstruction clamps exist without departing from the spirit and scope of the innovation described and claimed herein.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates elevation of a cable, comprising:
a housing having a locking cavity disposed therein, wherein the housing permits entry and exit of a pulling device; and
a locking mechanism disposed with the locking cavity that engages a device thereby facilitating termination of the device at an elevated level, wherein the device is attached to the cable.

2. The system of claim 1, further comprising the device that enables engagement at the elevated level and removal of the pulling device from ground level.

3. The system of claim 1, wherein the cable is a strength member having a plurality of fiber optic loops disposed along a length of the strength member.

4. The system of claim 1, wherein the locking mechanism is a free-floating locking pin.

5. The system of claim 4, wherein the locking pin is one of a galvanized or stainless steel pin.

6. The system of claim 4, wherein the pin is configured in the shape of a loop having two legs that prohibits either end to pivot in excess of 90 degrees.

7. The system of claim 1, wherein the pulling mechanism is one of a mule tape or rope.

8. The system of claim 1, further comprising a lid that enables access to the locking mechanism.

9. The system of claim 1, further comprising an attachment means that positions the housing at the elevated level.

10. The system of claim 1, wherein the housing is configured with a bottom surface tapered slot aperture that facilitates orientation of the dead-end device for engagement with the locking mechanism.

11. The system of claim 1, wherein the device is a helically wound wire tether having at least two loops, wherein a pulling mechanism is attached to one of the loops and the other of the loops engages with the locking mechanism, and wherein the pulling mechanism can be removed from ground level.

12. The system of claim 1, wherein the dead-end device is a spring loop wedge cap that includes a plurality of wedge blocks that grip the cable and a spring loop that facilitates engagement with the locking mechanism.

13. The system of claim 12, wherein the spring loop includes a secondary loop configured for installation by and removal of the pulling mechanism.

14. The system of claim 12, further comprising a crimp loop, wherein the crimp loop is attached to the spring loop and provides a secondary loop configured for installation by and removal of the pulling mechanism.

15. The system of claim 1, wherein the device is a tapered wedge cap having a hooking mechanism that facilitates installation by and removal of the pulling mechanism, and wherein the locking mechanism includes a plurality of spring clips that compress upon insertion and lock once in position at termination.

16. The system of claim 1, further comprising an obstruction clamp that prohibits access to the locking cavity.

17. The system of claim 16, wherein the obstruction clamp facilitates measurement of a length of the cable to the elevated level.

18. The system of claim 16, wherein the obstruction clamp includes a plurality of legs, wherein each of the plurality of legs is configured to snap-off or be snipped off in order to permit engagement of the locking mechanism.

19. A method for hoisting a cable, comprising:
positioning a hoist device at an elevated level;
dropping two lengths of a pulling mechanism to ground level;
fixedly connecting a dead-end to the cable;
removably connecting one of the two lengths of the pulling mechanism to the dead-end;
pulling the other of the two lengths of the pulling mechanism to lift the dead-end;
latching the dead-end within the hoist device at the elevated level; and
removing the puling mechanism from ground level.

20. The method of claim 19, wherein the pulling mechanism is a mule tape.

21. The method of claim 19, wherein the cable is a strength member having a plurality of fiber optic loops strategically disposed along its length.

22. The method of claim 19, wherein the act of positioning the hoist device employs a bracket assembly upon a knee wall of a structure.

23. The method of claim 19, further comprising hoisting an obstruction clamp to the hoist device to measure a height of the elevated level.

24. The method of claim 23, wherein the obstruction clamp prohibits entry into the hoist device.

25. The method of claim 19 wherein the obstruction clamp comprises a pair of legs, wherein each of the pair of legs is configured to snap-off or be snipped off in order to permit engagement of the locking mechanism.

26. A system, comprising:
means for attaching a wire device to a cable;
means for attaching the wire device to a pulling mechanism;
means for hoisting the wire device from ground level to an elevated level;
means for measuring the distance from ground level to the elevated level;
means for terminating the wire device at the elevated level; and
means for removing the pulling mechanism from ground level whereby the cable remains in an elevated and terminated state.
